(19) United States
(12) Patent Application Publication
(10) Pub. No.: US 2009/0172570 A1
(43) Pub. Date: Jul. 2, 2009

(54) MULTISCALED TRADE CARDS

(75) Inventors: Blaise Aguera y Arcas, Seattle, WA (US); Brett D. Brewer, Sammamish, WA (US); Steven Drucker, Bellevue, WA (US); Karim Farouki, Seattle, WA (US); Gary W. Flake, Bellevue, WA (US); Tomasz Kasperkiewicz, Redmond, WA (US); Stephen L. Lawler, Redmond, WA (US); Donald James Lindsay, Mountain View, CA (US); Adam Sheppard, Seattle, WA (US); Richard Stephen Szeliski, Bellevue, WA (US); Jeffrey Jon Weir, Seattle, WA (US); Julio Estrada, Medina, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 11/966,525

(22) Filed: Dec. 28, 2007

(51) Int. Cl. G06F 3/048

(52) U.S. Cl. 715/764

(57) ABSTRACT

The claimed subject matter provides a system and/or a method that facilitates interacting with a trade card that includes pyramidal volumes of data. A trade card with data can represent a computer displayable multiscale image with at least two substantially parallel planes of view in which a first plane and a second plane are alternatively displayable based upon a level of zoom and which are related by a pyramidal volume, wherein the image includes a pixel at a vertex of the pyramidal volume. An environment can host the trade card to enable access to a portion of the displayable multiscale image.

### CROSS REFERENCE TO RELATED APPLICATION(S)

This application relates to U.S. patent application Ser. No. 11/962,700 filed on Dec. 21, 2007, entitled “USER-CREATED TRADE CARDS,” and U.S. patent application Ser. No. 11/958,616 filed on Dec. 18, 2007, entitled “TRADE CARD SERVICES.” The entireties of such applications are incorporated herein by reference.

### BACKGROUND

Conventionally, browsing experiences related to web pages or other web-displayed content are comprised of images or other visual components of a fixed spatial scale, generally based upon settings associated with an output display screen resolution and/or the amount of screen real estate allocated to a viewing application, e.g., the size of a browser that is displayed on the screen to the user. In other words, displayed data is typically constrained to a finite or restricted space correlating to a display component (e.g., monitor, LCD, etc.).

In general, the presentation and organization of data (e.g., the Internet, local data, remote data, websites, etc.) directly influences one's browsing experience and can affect whether such experience is enjoyable or not. For instance, a website with data aesthetically placed and organized tends to have increased traffic in comparison to a website with data chaotically or randomly displayed. Moreover, interaction capabilities with data can influence a browsing experience. For example, typical browsing or viewing data is dependent upon a defined rigid space and real estate (e.g., a display screen) with limited interaction such as selecting, clicking, scrolling, and the like.

While web pages or other web-displayed content have created clever ways to attract a user's attention even with limited amounts of screen real estate, there exists a rational limit to how much information can be supplied by a finite display space—yet, a typical user usually necessitates a much greater amount of information be provided to the user.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate incorporating a trade card into a web page for multiscaled item or graphic with various views, levels, and/or resolutions for displayed data. This multiscaled item or graphic can appear as a typical element (e.g., image) within a web page, yet with seamless zooming and panning capabilities provided by an enhanced display engine, it can be a portal to virtually limitless high-resolution data via trade card features and characteristics. Moreover, the multiscaled item or trade card can be a portal to virtually limitless high-resolution data viewed at numerous levels or scales leveraging characteristics associated with the trade card. In general, the trade card can include pyramidal volumes of space for displaying or exposing data. Thus, the trade card can include multiple display layers or planes of view that are substantially parallel and that are alternatively displayable based upon a level of zoom. For example, zooming into a particular pixel at one plane of view can provide a seamless and realistic transition to lower planes of view, wherein each pixel can project a pyramidal volume to create an association with four pixels in the subsequent lower plane of view. Thus, standard web pages can replace ordinary images with a trade card having multiscaled data.

For example, a web page can include an advertisement image that, upon a zoom in with the display engine, can depict additional data. The trade card can be a uniform meta-data wrapper that is application neutral. In another aspect, a trade card can be a stand-alone item that need not be incorporated or associated with a web page, but rather an address (e.g., uniform resource locator (URL), Internet Protocol (IP) address, etc.). In still another aspect, the trade card can include an additional trade card embedded therein. In other aspects of the claimed subject matter, methods are provided that facilitate utilizing a trade card to display a plurality of data based upon a scale or view identified with a pan or a zoom.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates utilizing a trade card having portions of data that can be displayed or exposed based on a view level or scale.

FIG. 2 illustrates a block diagram of an exemplary system that facilitates a conceptual understanding of a trade card including a portion of image data.

FIG. 3 illustrates a block diagram of an exemplary system that facilitates embedding a portion of a trade card into a web page for an enhanced browsing experience that can display virtually limitless amounts of data.

FIG. 4 illustrates a block diagram of an exemplary system that facilitates implementing a plurality of trade cards that include portions of active data and/or static data.

FIG. 5 illustrates a block diagram of exemplary system that facilitates enhancing implementation of a trade card with a display technique, a browse technique, and/or a virtual environment technique.

FIG. 6 illustrates a block diagram of an exemplary system that facilitates utilizing a trade card having portions of data that can be displayed or exposed based on a view level or scale.

FIG. 7 illustrates an exemplary methodology for displaying content associated with a trade card based upon a view level identified by a zoom or pan.

FIG. 8 illustrates an exemplary methodology that facilitates utilizing a portion of a trade card with the Internet or a disparate trade card.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “engine,” “aggregator,” “network,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

It is to be appreciated that the subject innovation can be utilized with at least one of a display engine, a browsing engine, a content aggregator, and/or any suitable combination thereof A “display engine” can refer to a resource (e.g., hardware, software, and/or any combination thereof) that enables seamless panning and/or zooming within an environment in multiple scales, resolutions, and/or levels of detail, wherein detail can be related to a number of pixels dedicated to a particular object or feature that carry unique information. In accordance therewith, the term “resolution” is generally intended to mean a number of pixels assigned to an object, detail, or feature of a displayed image and/or a number of pixels displayed using unique logical image data. Thus, conventional forms of changing resolution that merely assign more or fewer pixels to the same amount of image data can be readily distinguished. Moreover, the display engine can create space volume within the environment based on zooming out from a perspective view or reduce space volume within the environment based on zooming in from a perspective view. Furthermore, a “browsing engine” can refer to a resource (e.g., hardware, software, and/or any suitable combination thereof) that employs seamless panning and/or zooming at multiple scales with various resolutions for data associated with an environment, wherein the environment is at least one of the Internet, a network, a server, a website, a web page, and/or a portion of the Internet (e.g., data, audio, video, text, image, etc.). Additionally, a “content aggregator” can collect two-dimensional data (e.g., media data, images, video, photographs, metadata, etc.) to create a three dimensional (3D) virtual environment that can be explored (e.g., browsing, viewing, and/or roaming such content and each perspective of the collected content).

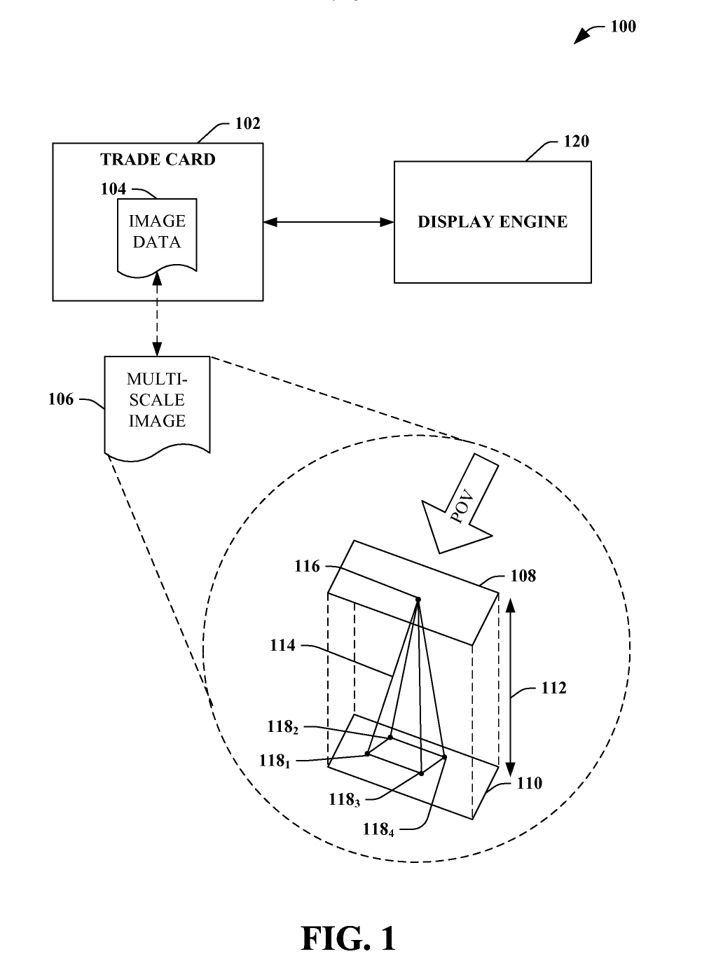

Now turning to the figures, FIG. 1 illustrates a system 100 that facilitates utilizing a trade card having portions of data that can be displayed or exposed based on a view level or scale. Generally, system 100 can include a trade card 102 with image data 104 that can represent, define, and/or characterize computer displayable multiscale image 106, wherein a display engine 120 can access and/or interact with at least one of the trade card 102 or the image data 104. In particular, image 104 can include two or more substantially parallel planes of view (e.g., layers, scales, etc.) that can be alternatively displayable, as encoded in image data 104 of trade card 102. For example, image 106 can include first plane 108 and second plane 110, as well as virtually any number of additional planes of view, any of which can be displayable and/or viewed based upon a level of zoom 112. For instance, planes 108, 110 can each include content, such as on the upper surfaces that can be viewable in an orthographic fashion. At a higher level of zoom 112, first plane 108 can be viewable, while at a lower level zoom 112 at least a portion of second plane 110 can replace on an output device what was previously viewable.

Moreover, planes 108, 110, et al., can be related by pyramidal volume 114 such that, e.g., any given pixel in first plane 108 can be related to four particular pixels in second plane 110. It should be appreciated that the indicated drawing is merely exemplary, as first plane 108 need not necessarily be the top-most plane (e.g., that which is viewable at the highest level of zoom 112), and, likewise, second plane 110 need not necessarily be the bottom-most plane (e.g., that which is viewable at the lowest level of zoom 112). Moreover, it is further not strictly necessary that first plane 108 and second plane 110 be direct neighbors, as other planes of view (e.g., at interim levels of zoom 112) can exist in between, yet even in such cases the relationship defined by pyramidal volume 114 can still exist. For example, each pixel in one plane of view can be related to four pixels in the subsequent next lower plane of view, and to 116 pixels in the next subsequent plane of view, and so on. Accordingly, the number of pixels included in pyramidal volume at a given level of zoom, l, can be described as p=4^{l}, where l is an integer index of the planes of view and where l is greater than or equal to zero. It should be appreciated that p can be, in some cases, greater than a number of pixels allocated to image 106 (or a layer thereof) by a display device (not shown) such as when the display device allocates a relatively small number of pixels to image 106 with other content subsuming the remainder or when the limits of physical pixels available for the display device or a viewable area is reached. In these or other cases, p can be truncated or pixels described by p can become viewable by way of panning image 106 at a current level of zoom 112.

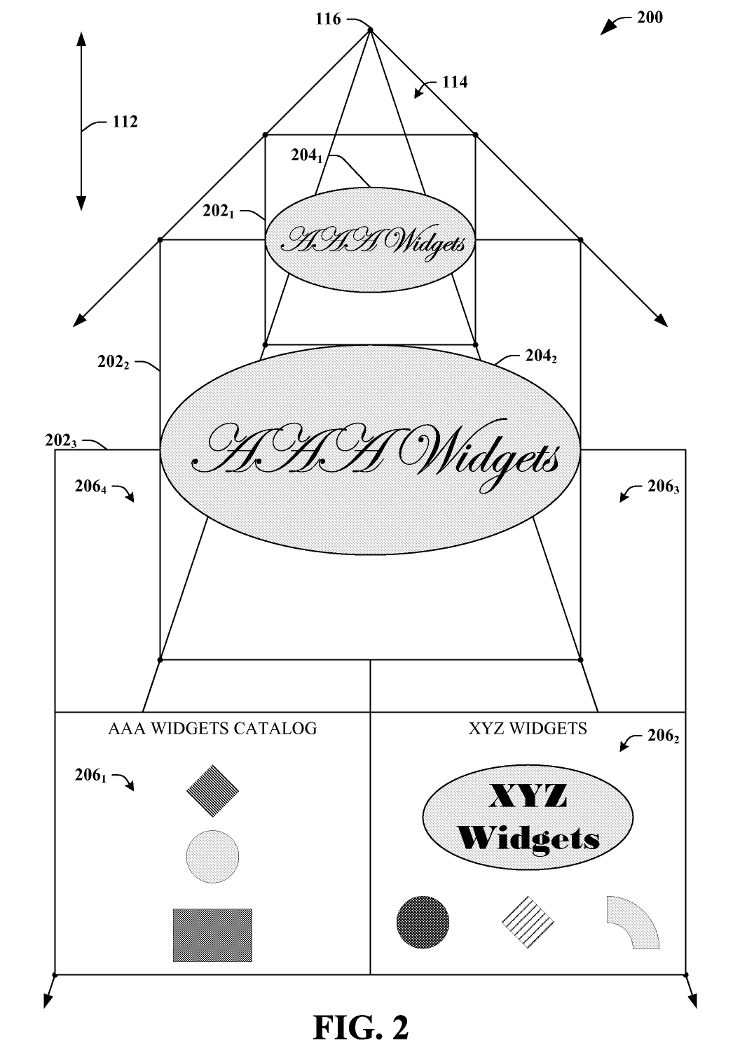

However, in order to provide a concrete illustration, first plane 108 can be thought of as a top-most plane of view (e.g., l=0) and second plane 110 can be thought of as the next sequential level of zoom 112 (e.g., l=1), while appreciating that other planes of view can exist below second plane 110, all of which can be related by pyramidal volume 114. Thus, a given pixel in first plane 108, say, pixel 116, can by way of a pyramidal projection be related to pixels 118₁-118₄ in second plane 110. The relationship between pixels included in pyramidal volume 114 can be such that content associated with pixels 118₁-118₄ can be dependent upon content associated with pixel 116 and/or vice versa. It should be appreciated that each pixel in first plane 108 can be associated with four unique pixels in second plane 110 such that an independent and unique pyramidal volume can exist for each pixel in first plane 108. All or portions of planes 108, 110 can be displayed by, e.g., a physical display device with a static number of physical pixels, e.g., the number of pixels a physical display device provides for the region of the display that displays image 106 and/or planes 108, 110. Thus, physical pixels allocated to one or more planes of view may not change with changing levels of zoom 112, however, in a logical or structural sense (e.g., data included in trade card 102 or image data 104) each success lower level of zoom 112 can include a plane of view with four times as many pixels as the previous plane of view, which is further detailed in connection with FIG. 2, described below.

It is to be appreciated that the trade card 102 can be a summarization of a portion of data. For instance, a trade card can be a summarization of a web page in which the trade card can include key phrases, dominant images, spec information (e.g., price, details, etc.), contact information, etc. Thus, the trade card is a summarization of important, essential, and/or key aspects and/or data of the web page. The trade card 102 can include various views, displays, and/or levels of data in which each can include a respective scale or resolution. It is to be appreciated that such views, displays or levels of data can be utilized with at least one of a zoom (e.g., zoom in, zoom out, etc.) or pan (e.g., pan left, pan right, pan up, pan down, any suitable combination thereof, etc.). Thus, a portion of a trade card can include a first view at a high resolution and a zoom in can reveal additional data at a disparate view and a disparate resolution. In other words, the zoom in can display the first view in a more magnified view but also reveal additional information or data. Moreover, it is to be appreciated that the trade card 102 can include any suitable data determined to be essential for the distillation of content (e.g., a document, website, a product, a good, a service, a link, a collection of data that can be browsed, etc.) such as static data, active data, and/or any suitable combination thereof For example, the trade card 102 can include an image, a portion of text, a gadget, an applet, a real time data feed, a portion of video, a portion of audio, a portion of a graphic, etc.

The trade card 102 can further be utilized in any suitable environment, in any suitable platform, on any suitable device, etc. In other words, the trade card 102 can be universally compatible with any suitable environment, platform, device, etc. such as a desktop computer, a component, a machine, a machine with a windows-based operating system, a media device, a portable media player, a cellular device, a portable digital assistant (PDA), a gaming device, a laptop, a web-browsing device regardless of operating system, a gaming console, a portable gaming device, a mobile device, a portion of hardware, a portion of software, a smartphone, a wireless device, a third-party service, etc. In another example, the trade card 102 can display particular information based at least in part upon 1) an environment utilizing such trade card; or 2) a user or machine utilizing the trade card. In other words, the trade card 108 can be granular and include various sections or portions of data, wherein such granularity or portion of data can be displayed based upon a user or machine utilizing such trade card.

For instance, a user can create a trade card representative of a particular service or product, wherein the trade card can be a distillation of product or service specific data. The trade card, for example, can include various data such as important images, specification information (e.g., size, weight, color, material composition, etc.), cost, vendors, make, model, version, and/or any other information the user includes into the trade card. In other words, the trade card can be a summarization of product or service data in which the summarization data is selected by the user. The trade card can further include various links, relationships, and/or affiliations, in which the relationship, links, and/or affiliations can be with at least one of the Internet, a disparate trade card, the network 106, a server, a host, and/or any other suitable environment associated with a trade card.

Turning now to FIG. 2, example image 106 is illustrated to facilitate a conceptual understanding of image data 104 and/or trade card 102. In this example, image 106 includes four planes of view, with each plane being represented by pixels that exist in pyramidal volume 114. For the sake of simplicity, each plane of view includes only pixels included in pyramidal volume 114; however, it should be appreciated that other pixels can also exist in any or all of the planes of view although such is not expressly depicted. For example, the top-most plane of view includes pixel 116, but it is readily apparent that other pixels can also exist as well. Likewise, although not expressly depicted, planes 202₁-202₃, which are intended to be sequential layers and to potentially exist at much lower levels of zoom 112 than pixel 116, can also include other pixels. [0030] In general, planes 202₁-202₃ can represent space for distilled content or data. In this case, the trade card 102 can include data related to “AAA widgets” who fills space with the information that is essential thereto (e.g., company's familiar trademark, logo 204₁, etc.). As the level of zoom 112 is lowered to plane 202₂, what is displayed in the space can be replaced by other data so that a different layer of image 106 can be displayed, in this case logo 204₂. In an aspect of the claimed subject matter, one plane can display all or a portion another plane at a different scale, which is illustrated by planes 202₂, 202₁, respectively. In particular, plane 202₂ includes about four times the number of pixels as plane 202₁, yet associated logo 204₂ need not be merely a magnified version of logo 204₁ that provides no additional detail and can lead to “chucky” rendering, but rather can be displayed at a different scale with an attendant increase in the level of detail.

Additionally or alternatively, a lower plane of view can display content that is graphically or visually unrelated to a higher plane of view (and vice versa). For instance, as depicted by planes 202₂ and 202₃ respectively, the content can change from logo 204₂ to, e.g., content described by reference numerals 206₁-206₄. Thus, in this case, the next level of zoom 112 provides a product catalog associated with the AAA Widgets company and also provides advertising content for a competitor, “XYZ Widgets” in the region denoted by reference numeral 206₂. Other content can be provided as well in the regions denoted by reference numerals 206₃-206₄.

By way of further explanation consider the following holistic example. Pixel 116 is output to a user interface device and is thus visible to a user, perhaps in a portion of viewable content allocated to web space. As the user zooms (e.g., changes the level of zoom 112) into pixel 116, additional planes of view can be successively interpolated and resolved and can display increasing levels of detail. Eventually, the user zooms to plane 202₁ and other planes that depict more detail at a different scale, such as plane 202₂. However, a successive plane need not be only a visual interpolation and can instead include content that is visually or graphically unrelated such as plane 202₃. Upon zooming to plane 202₃, the user can peruse the content displayed, possibly zooming into the product catalog to reach lower levels of zoom relating to individual products and so forth.

Additionally or alternatively, it should be appreciated that logos 204₁, 204₂ can be a composite of many objects, say, images of products included in one or more product catalogs that are not discernible at higher levels of zoom 112, but become so when navigating to lower levels of zoom 112, which can provide a realistic and natural segue into the product catalog featured at 206₁, as well as, potentially that for XYZ Widgets included at 206₂. In accordance therewith, a top-most plane of view, say, that which includes pixel 116 need not appear as content, but rather can appear, e.g., as an aesthetically appealing work of art such as a landscape or portrait; or, less abstractly can relate to a particular domain such as a view of an industrial device related to widgets. Naturally countless other examples can exist, but it is readily apparent that pixel 116 can exist at, say, the stem of a flower in the landscape or at a widget depicted on the industrial device, and upon zooming into pixel 116 (or those pixels in relative proximity), logo 204₁ can become discernible.

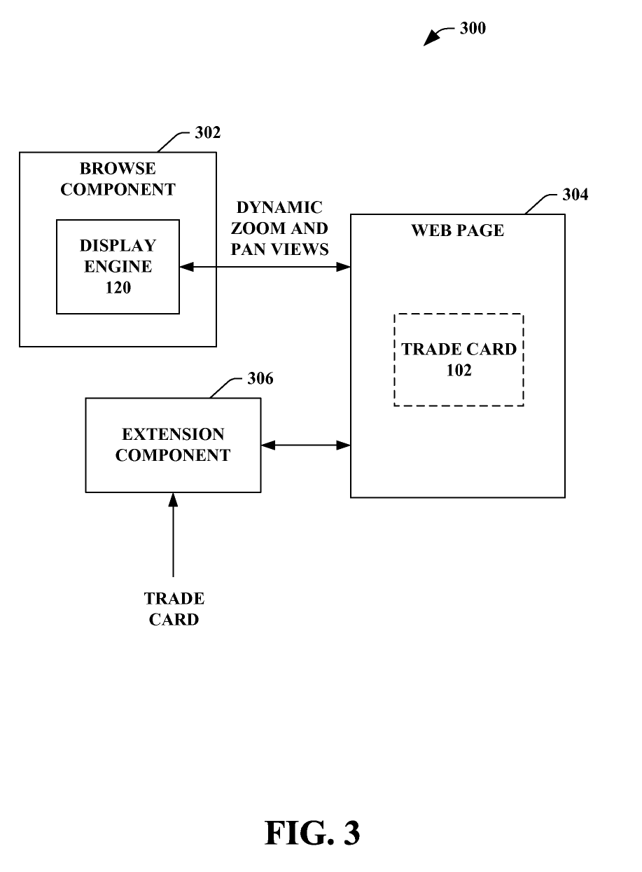

FIG. 3 illustrates a system 300 that facilitates embedding a portion of a trade card into a web page for an enhanced browsing experience that can display virtually limitless amounts of data. The system 300 can include the display engine 120 that can interact with the trade card 102 to utilize various features associated therewith. For instance, the display engine 120 can allow seamless zooms, pans, and the like which can expose portions of data based upon a location on the trade card 102 or a zoom into or out of the trade card 102. In general, the display engine 120 can provide intra trade card zoom and/or zooming and/or panning across a plurality of trade cards. In other words, the display engine 120 can utilize any suitable user interface (UI) to manipulate one or more trade cards 102.

The system 300 can further include a browse component 302 that can leverage the display engine 120 in order to allow interaction or access with a portion of the trade card 102 across a network, server, the web, the Internet, and the like. In particular, the trade cad 102 can be incorporated or embedded into a web page 304, wherein the browse component 302 can interact with at least one of the web page 304 or the trade card 102. It is to be appreciated that the browse component 302 can be any suitable data browsing component such as, but not limited to, a potion of software, a portion of hardware, a media device, a mobile communication device, a laptop, a browser application, a smartphone, a portable digital assistant (PDA), a media player, a gaming device, and the like. Moreover, it is to be understood that the trade card 102 can be incorporated or published into any suitable environment such as the web page 304, a network (not shown), a web address, a uniform resource locator (URL), a server, a portion of computer readable medium, a portion of the Internet, and the like. In other words, the trade card 102 can be published or exposed to users for access in any suitable environment. For instance, a trade card can be incorporated into a personal web site. In another example, a URL can direct traffic to a specific trade card not embedded in a web site. In still another example, a web address can direct traffic to a plurality of trade cards. Thus, a user can browse or explore such trade cards with the display engine 120 or the browse component 302 independent of the host environment.

The system 300 can further include an extension component 306. The extension component 306 can receive a portion of the trade card 102 and enable seamless incorporate or publication to allow access thereto. For example, a trade card can be created (e.g., user-created, web-service created, automatically created, etc.) and published to a website or web space, wherein users can interact or browse the portion of the trade card 102 accordingly. Furthermore, the extension component 306 can incorporate at least one portion of the trade card 102 into a server, a network, the web, the Internet, a web space, and the like. In other words, the extension component 306 can publish a first level or layer of the trade card 102 to a first environment, whereas a disparate level may not be exposed or can be exposed to a second environment. It is to be appreciated that the trade card 102 can be published or incorporated into various environments in which numerous portions of the trade card 102 can be exposed (e.g., a section or portion of the trade card 102 is exposed or published based on the environment).

In addition, a portion of the trade card can be exposed or displayed based at least in part upon the environment in which the trade card is utilized. For example, a portion of the trade card can be viewable or usable on a mobile device, wherein such portion may not be available on a laptop device. In addition, various security settings can be employed for the trade card 108. In other words, a portion of a trade card can be accessible to a close friend but not a stranger.

It is to be appreciated that the trade card 102 with the multi-scaled item or graphic can appear as a typical element (e.g., image) within the web page 304, yet with seamless zooming and panning capabilities provided by the display engine 120, it can be a portal to virtually limitless high-resolution data via trade card features and characteristics. Moreover, the multi-scaled item or trade card can be a portal to virtually limitless high-resolution data viewed at numerous levels leveraging characteristics associated with the trade card 102. Thus, standard web pages can replace ordinary images with a trade card having multi-scaled data. For example, a web page can include an advertisement image that, upon a zoom in with the display engine, can depict additional data. The trade card can be a uniform meta-data wrapper that is application neutral. In another aspect, a trade card can be a stand-alone item that need not be incorporated or associated with a web page, but rather an address (e.g., uniform resource locator (URL), Internet Protocol (IP) address, etc.). In still another aspect, the trade card can include an additional trade card embedded therein.

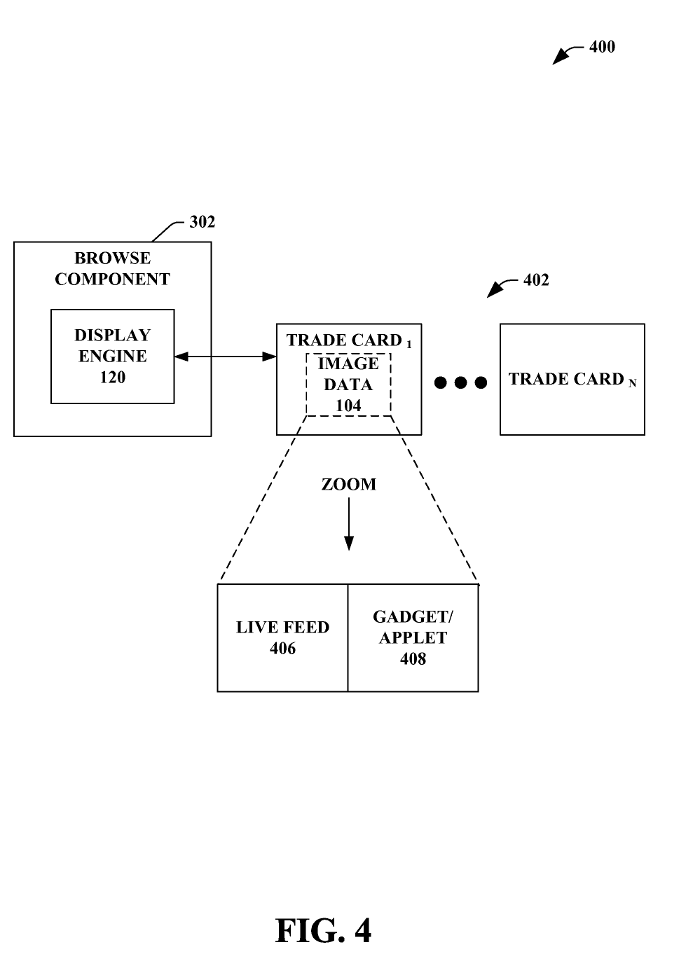

FIG. 4 illustrates a system 400 that facilitates implementing a plurality of trade cards that include portions of active data and/or static data. The system 400 can include the display engine 120 that can provide dynamic and seamless panning and/or zooming on one or more trade cards 402. It is to be appreciated that there can be any suitable number of trade cards 402 such as, but not limited to, trade card₁ to trade card_{N}, where N is a positive integer. The trade card 102 can be browsed internally or a plurality of trade cards can be browsed or explored. In other words, a trade card can be browsed in which a user can zoom to a layer (e.g., upper, lower, etc.) or navigate to a location (e.g., panning left, panning right, panning up, panning down, panning diagonal, etc.) on specific layer, wherein particular portions of data are displayed in accordance with such layer and/or location.

As depicted in FIG. 4, the plurality of trade cards 402 can be explored or a specific trade card can be browsed internally. For example, a trade card can include a portion of image data 104 that can be zoomed upon to expose and/or reveal additional portions of data. It is to be appreciated that the additional portions of data can be, but are not limited to being, magnified representations of the initial view or level, a portion of an image, a portion of a graphic, a portion of audio, a portion of video, a portion of an application, a portion of a file format, a portion of a file, etc. In particular, the trade card and image data 104 can be zoomed in order to expose a live feed 406 or a gadget/applet 408. In other words, the trade card can include active data as well as static data. In another example, the trade card can expose or reveal an editorial experience (discussed below). In still another example, the additional potions of data can be exposed or revealed based on the level zoomed or location navigated or on a time duration on a particular location or level. In other words, a user can navigate to a particular level on the trade card or a specific location on a trade card level in which the duration or time spent browsing on such area can trigger the exposure or revealing of additional data.

As discussed, the trade card can include an editorial experience. The editorial experience can be any suitable collection of data gathered based upon a creator of the particular trade card. For instance, the editorial experience can be any suitable portion of audio, text, graphic, or video that a creator aggregates in order portray his or her thoughts related to the created trade card. In one example, a trade card for a product can include an editorial experience that is a video of a creator using such product. In another example, a trade card created by a disparate user for the product can include an editorial experience that is a website for the creator or product. Moreover, the editorial experience can correlate to the particular environment that the trade card is utilized. Thus, a first editorial exposure for a trade card can be employed for a first environment and a second editorial exposure for the trade card can be employed in a second environment.

It is to be appreciated that the trade card 102 can be syndicated to various environments. The syndication can allow a portion of a trade card to be syndicated (e.g., web syndication, etc.). For instance, web syndication can be a web feed to various entities such as, but not limited to, a website, a disparate trade card, a network, a server, a user, a web address, an email address, a device (e.g., mobile device, gaming device, etc.), and/or any other suitable host or environment that can utilize a portion of the trade card. Moreover, the syndication can be a granular-type syndication, wherein portions of the trade card 102 can be utilized for syndication.

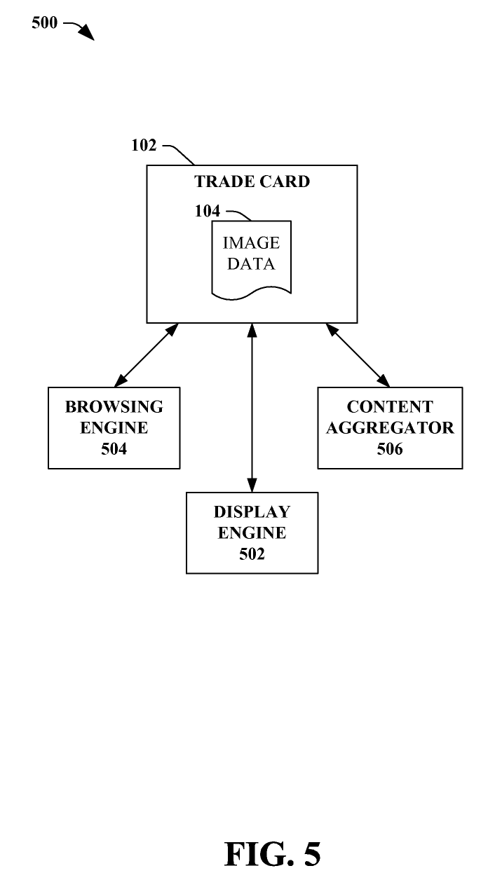

FIG. 5 illustrates a system 500 that facilities enhancing implementation of a trade card with a display technique, a browse technique, and/or a virtual environment technique. The system 500 can include the build component 102, the web service 104, the interface 106, and/or the trade cards 108. The system 500 can further include a display engine 502 that enables seamless pan and/or zoom interaction with any suitable displayed data (e.g., a trade card), wherein such data can include multiple scales or views and one or more resolutions associated therewith. In other words, the display engine 502 can manipulate an initial default view for displayed data by enabling zooming (e.g., zoom in, zoom out, etc.) and/or panning (e.g., pan up, pan down, pan right, pan left, etc.) in which such zoomed or panned views can include various resolution qualities. The display engine 502 enables visual information to be smoothly browsed regardless of the amount of data involved or bandwidth of a network. Moreover, the display engine 502 can be employed with any suitable display or screen (e.g., portable device, cellular device, monitor, plasma television, etc.). The display engine 502 can further provide at least one of the following benefits or enhancements: 1) speed of navigation can be independent of size or number of objects (e.g., data); 2) performance can depend on a ratio of bandwidth to pixels on a screen or display; 3) transitions between views can be smooth; and 4) scaling is near perfect and rapid for screens of any resolution.

For example, an image (e.g., a portion of a trade card) can be viewed at a default view with a specific resolution. Yet, the display engine 502 can allow the image to be zoomed and/or panned at multiple views or scales (in comparison to the default view) with various resolutions. Thus, a user can zoom in on a portion of the image to get a magnified view at an equal or higher resolution. By enabling the image to be zoomed and/or panned, the image can include virtually limitless space or volume that can be viewed or explored at various scales, levels, or views with each including one or more resolutions. In other words, an image can be viewed at a more granular level while maintaining resolution with smooth transitions independent of pan, zoom, etc. Moreover, a first view may not expose portions of information or data on the image until zoomed or panned upon with the display engine 502.

A browsing engine 504 can also be included with the system 500. The browsing engine 504 can leverage the display engine 502 to implement seamless and smooth panning and/or zooming for any suitable data browsed in connection with at least one of the Internet, a network, a server, a website, a web page, and the like. It is to be appreciated that the browsing engine 504 can be a stand-alone component, incorporated into a browser, utilized with in combination with a browser (e.g., legacy browser via patch or firmware update, software, hardware, etc.), and/or any suitable combination thereof. For example, the browsing engine 504 can be incorporate Internet browsing capabilities such as seamless panning and/or zooming to an existing browser. For example, the browsing engine 504 can leverage the display engine 502 in order to provide enhanced browsing with seamless zoom and/or pan on a website, wherein various scales or views can be exposed by smooth zooming and/or panning.

The system 500 can further include a content aggregator 506 that can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). For instance, the content aggregator 506 can aggregate a large collection of photos of a place or an object, analyze such photos for similarities, and display such photos in a reconstructed 3D space, depicting how each photo relates to the next. It is to be appreciated that the collected content can be from various locations (e.g., the Internet, local data, remote data, server, network, wirelessly collected data, etc.). For instance, large collections of content (e.g., gigabytes, etc.) can be accessed quickly (e.g., seconds, etc.) in order to view a scene from virtually any angle or perspective. In another example, the content aggregator 506 can identify substantially similar content and zoom in to enlarge and focus on a small detail. The content aggregator 506 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently viewed content; and 5) communicate a collection or a particular view of content to an entity (e.g., user, machine, device, component, etc.).

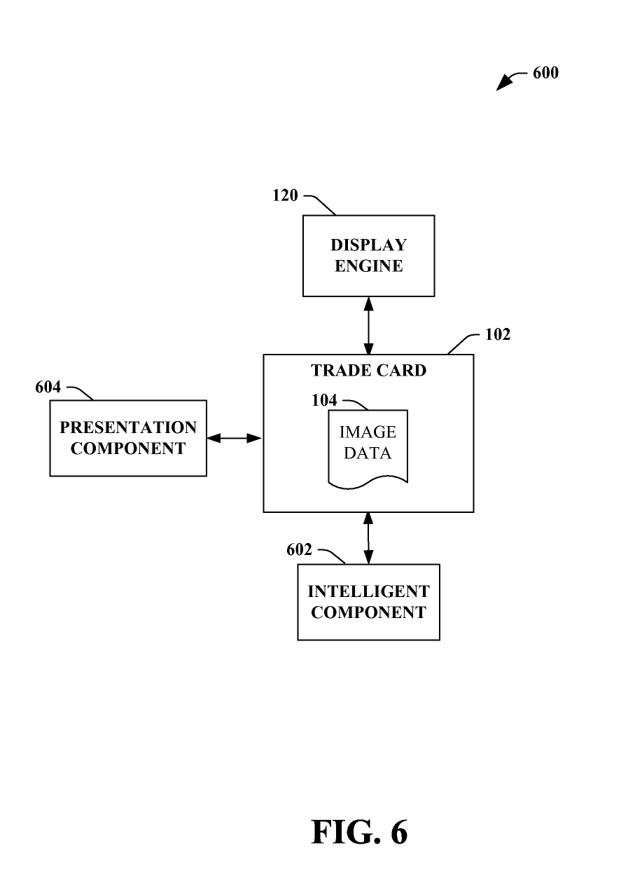

FIG. 6 illustrates a system 600 that employs intelligence to facilitate utilizing a trade card having portions of data that can be displayed or exposed based on a view level or scale. The system 600 can include the trade card 102, image data 104, and the display engine 120. It is to be appreciated that the trade card 102, image data, and/or the display engine 120 can be substantially similar to respective trade cards, image data, and display engines described in previous figures. The system 600 further includes an intelligent component 602. The intelligent component 602 can be utilized by at least one of the trade card 102 or the display engine 120 to facilitate utilizing or interacting with a portion of a trade card. For example, the intelligent component 602 can infer which portions of data to expose or reveal for a user based on a navigated location or layer within the trade card 102. For instance, a first portion of data can be exposed to a first user navigating a trade card and a second portion of data can be exposed to a second user navigating the trade card. Such user-specific data exposure can be based on user settings (e.g., automatically identified, user-defined, inferred user preferences, etc.). Moreover, the intelligent component 602 can infer optimal publication or environment settings, display engine settings, security configurations, durations for data exposure, and/or any other data related to the system 600.

The intelligent component 602 can employ value of information (VOI) computation in order to identify content on a trade card to expose or reveal for a particular user. For instance, by utilizing VOI computation, the most ideal and/or trade card content can be identified for a specific user. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The system 600 can further utilize a presentation component 604 that provides various types of user interfaces to facilitate interaction between a user a trade card or any component coupled to at least one of the trade card 102 or the display engine 120. As depicted, the presentation component 604 is a separate entity that can be utilized with the trade card 102. However, it is to be appreciated that the presentation component 604 and/or similar view components can be incorporated into the trade card 102, incorporated into the display engine 120, and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into at least one of the trade card 102 or the display engine 120.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

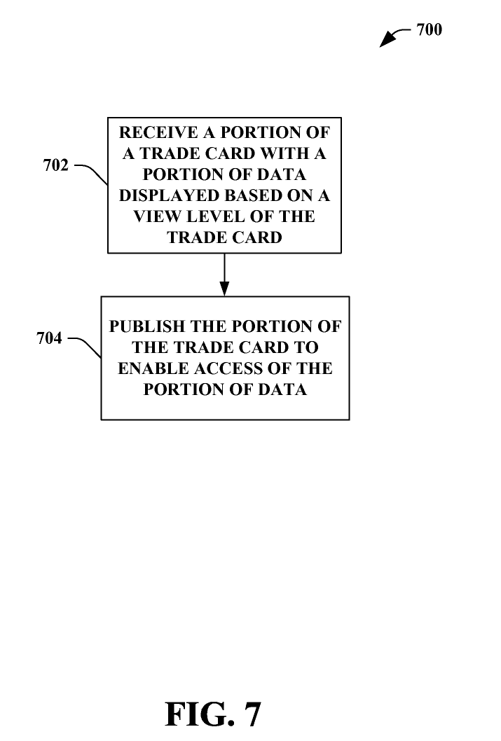

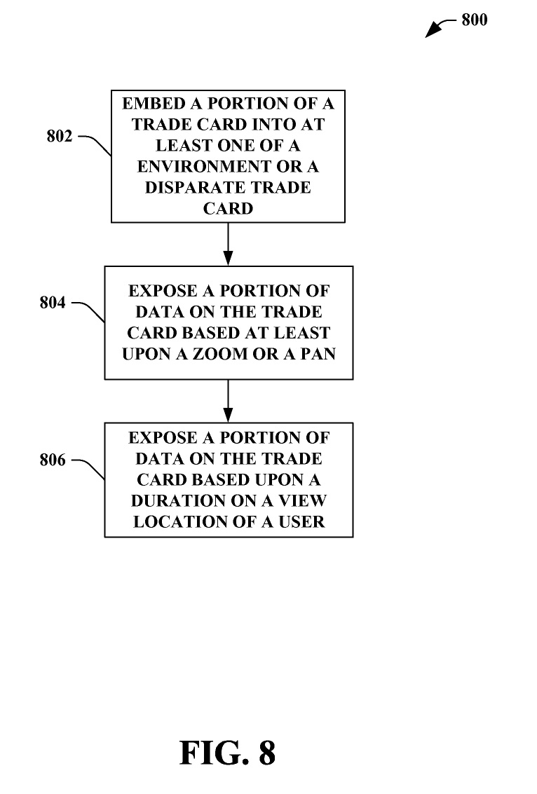

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates displaying content associated with a trade card based upon a view level identified by a zoom or pan. At reference numeral 702, a portion of a trade card can be received with a portion of data displayed based on a view level of the trade card. In particular, a trade card can include various layers, views, and/or scales associated therewith. Thus, a trade card can include a default view wherein a zooming in can dive into the trade card to deeper levels, layers, views, and/or scales. It is to be appreciated that diving (e.g., zooming into the trade card at a particular location) into the trade card can provide at least one of the default view on such location in a magnified depiction, exposure of additional data not previously displayed at such location, or active data revealed based on the deepness of the dive and/or the location of the origin of the dive.

It is to be appreciated that once a zoom in on a trade card is performed, a zoom out can also be employed which can provide additional data, de-magnified views, and/or any combination thereof. Thus, a first dive from a first location with image A can expose a set of data, whereas a zoom out back to the first location can display image A, another image, additional data, etc. Additionally, the trade card can be navigated with pans across a particular level, layer, scale, or view. Thus, a surface area of a level and be browsed with seamless pans.

At reference numeral 704, the portion of the trade card can be published in order to enable access of the portion of the data related therewith. A portion of a trade card can be published to an environment, wherein the environment can be but is not limited to, a device, a mobile device, a portable digital assistant (PDA), a gaming device, a mobile communication device, a cellular device, a smartphone, a handheld, a pocket PC, a desktop computer, a cloud (e.g., a collection of resources that can be accessed by a user, etc.), a machine, a laptop, a server, a network, a web page, a website, a portion of the web, a portion of the Internet, a portion of computer readable medium, and the like. For example, the publication for a portion of the trade card can allow a user, machine, entity (e.g., group, forum, company, application, hardware, business, etc.), etc. to access or interact with such trade card. For instance, publishing or posting the trade card to a website can allow various Internet users to display and interact with the trade card with respective levels, views, scales, etc.

FIG. 8 illustrates a method 800 for utilizing a portion of a trade card with the Internet or a disparate trade card. At reference numeral 802, a portion of a trade card can be embedded into at least one of an environment or a disparate trade card. For example, the trade card can be incorporated into an environment which can be accessed or interacted with by a user or machine. In particular, a trade card can be hosted or incorporated into a web page, wherein upon browsing or navigating such web page, a user can view, interact (e.g., click, receive data, etc.), or navigate (e.g., zoom, pan, explore, etc.) with such trade card. In addition, a portion of a trade card can be incorporated or embedded into another trade card. Thus, a user can view a default view of a first trade card, dive into another view or level, and another trade card can be exposed or revealed. The user can then explore the additional trade card and can dive into the various levels, views, scales, etc. accordingly.

At reference numeral 804, a portion of data on the trade card can be exposed based at least in part upon a zoom or a pan. For instance, an initial view of a trade card can include various data which can be a distillation of content for a particular item, good, service, etc. A zoom, pan, or other navigation to a particular location on the trade card can expose or reveal additional data. Furthermore, a zoom or dive into or out of the trade card can expose levels, views, scales, and the like to which various planes of data can exists. Thus, a user can pan a planar level of a trade card to which a location can correspond to a portion of data, whereas a zoom or dive can navigate to a disparate planar level on the trade card and such location can correspond to disparate portions of data. At reference numeral 806, a portion of data on the trade card can be exposed based upon duration on a view location of a user. In other words, in addition to a location (e.g., a planar location on a specific level or a particular level, scale, view, etc.), additional data can be exposed on the trade card based on a time-release. Thus, a user navigating on a trade card can be exposed to additional data based upon an amount of time or duration on a particular location or level.

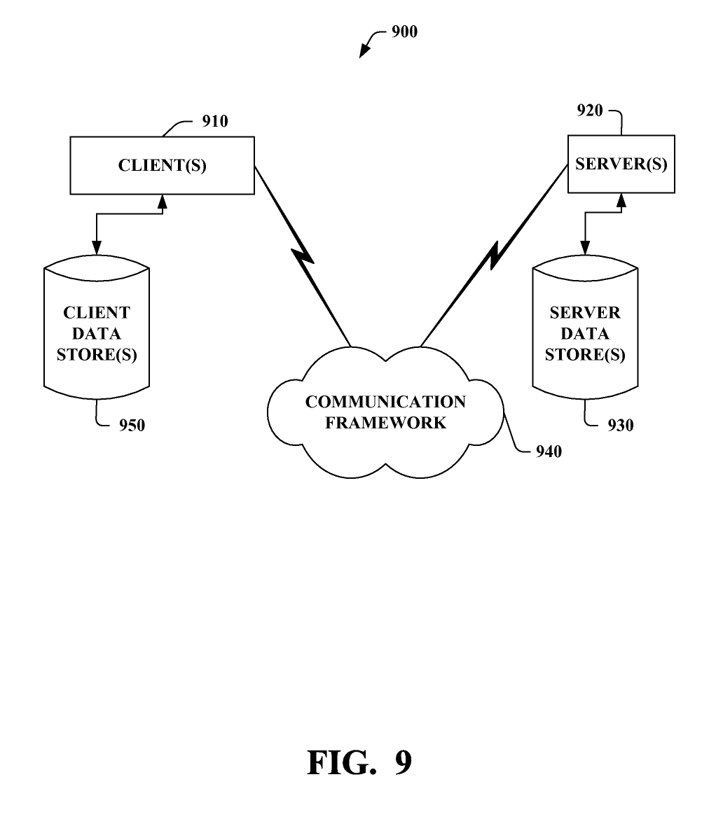

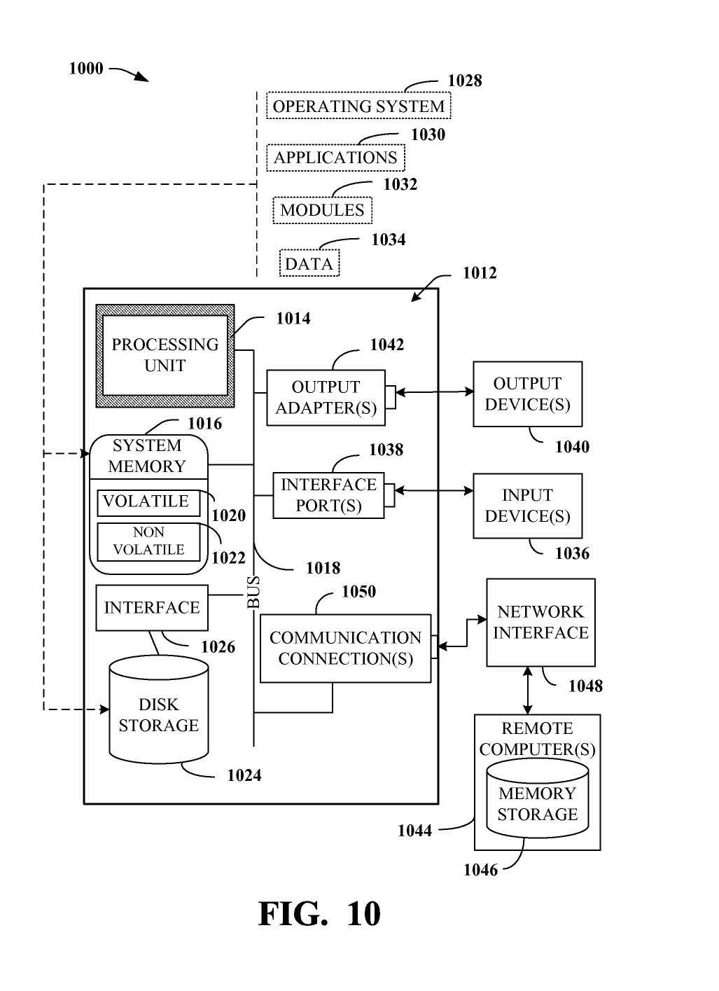

In order to provide additional context for implementing various aspects of the claimed subject matter, FIGS. 9-10 and the following discussion is intended to provide a brief, general description of a suitable computing environment in which the various aspects of the subject innovation may be implemented. For example, a trade card with various view levels that is leveraged by a display engine, as described in the previous figures, can be implemented or utilized in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer-implemented system that facilitates interacting with a trade card that includes pyramidal volumes of data, comprising:
a trade card with data that represents a computer displayable multiscale image with at least two substantially parallel planes of view in which a first plane and a second plane are alternatively displayable based upon a level of zoom and which are related by a pyramidal volume, the image includes a pixel at a vertex of the pyramidal volume; and
an environment that hosts the trade card to enable access to at least one of the trade card or a portion of the displayable multiscale image.

2. The system of claim 1, the second plane of view displays a portion of the first plane of view at one of a different scale or a different resolution.

3. The system of claim 1, the second plane of view displays a portion of the trade card that is graphically or visually unrelated to the first plane of view.

4. The system of claim 1, the second plane of view displays a portion of a trade card that is disparate than the portion of the trade card associated with the first plan of view.

5. The system of claim 1, the trade card includes the portion of data as a distillation of information identified as essential to a topic of such trade card, wherein the portion of data includes at least one of static data or active data.

6. The system of claim 1, the trade card incorporates at least one of a portion of a graphic, a portion of audio, a portion of video, a portion of an image, a portion of text, an applet, a gadget, a real-time feed, a live feed, or a real-time data update.

7. The system of claim 1, the trade card is granular with one or more sections of data, each section includes at least one of a view, a scale, or a resolution, the trade card granularity is determined based upon at least one of a zoom on the trade card or a pan on the trade card.

8. The system of claim 1, the trade card is universally implemented in the environment independent of a format for the environment, the environment is at least one of a website, a portion of the web, a portion of the Internet, a web page, a disparate trade card, a network, a server, a uniform resource locator (URL), a web address, an Internet Protocol (IP) address, a desktop computer, a component, a machine, a machine with a windows-based operating system, a media device, a portable media player, a cellular device, a portable digital assistant (PDA), a gaming device, a laptop, a web-browsing device, a gaming console, a portable gaming device, a mobile device, a portion of hardware, a portion of software, a smartphone, a wireless device, or a third-party service.

9. The system of claim 1, at least one portion of the trade card is exposed based at least in part upon one of the following:
the environment accessing the trade card;
a location on a plane of view for the trade card;
a plane of view associated with the trade card; or
a user accessing the trade card.

10. The system of claim 1, further comprising a display engine that enables at least one of the following:
dynamic zooming and panning on the trade card;
intra trade card navigation; or
navigation of a plurality of trade cards.

11. The system of claim 1, further comprising a cloud that hosts at least one of the trade card, the display engine, or the multiscale image, wherein the cloud is at least one resource that is maintained by a party and accessible by an identified user over a network.

12. The system of claim 1, further comprising an extension component that receives a portion of the trade card and enables seamless publication to allow access thereto.

13. The system of claim 12, the portion of trade card is received from a web service, a user, a machine, a website, a company, or a business.

14. The system of claim 1, the trade card exposes a portion of data based at least in part upon an amount of time spent navigating on a particular location on a plane of the trade card or a location on a plane of the trade card.

15. The system of claim 1, the first plane is published to a first environment and the second plane is published to a second environment.

16. The system of claim 1, further comprising a browse component that leverages the display engine to allow interaction with a portion of the trade card across a communication medium.

17. A computer-implemented method that facilitates hosting a portion of a trade card to enable accessibility, comprising:
receiving a portion of a trade card, the trade card includes a portion of data that is displayed based upon a navigated view level on the trade card; and
publishing the portion of the trade card to enable access of the portion of data.

18. The method of claim 17, the trade card includes a computer displayable multiscale image with at least two substantially parallel planes of view in which a first plane and a second plane are alternatively displayable based upon a level of zoom and which are related by a pyramidal volume, the image includes a pixel at a vertex of the pyramidal volume.

19. The method of claim 17, further comprising:
embedding a portion of the trade card into at least one of an environment or a disparate trade card;
exposing a portion of data on the trade card based upon a navigated location, the navigated location is at least one of a layer associated with the trade card or a location on a particular layer related to the trade card; and
exposing a portion of data on the trade card based upon a duration spent on the navigated location.

20. A computer-implemented system that facilitates utilizing a trade card that displays a portion of data on a network, comprising:
means for representing a computer displayable multiscale image in a trade card with at least two substantially parallel planes of view in which a first plane and a second plane are alternatively displayable based upon a level of zoom and which are related by a pyramidal volume, the image includes a pixel at a vertex of the pyramidal volume; and
means for hosting the trade card to enable access to at least one of the trade card or a portion of the displayable multiscale image.
